(19) United States
(12) Patent Application Publication
(10) Pub. No.: US 2024/0177210 A1
(43) Pub. Date: May 30, 2024

(54) ENTITY ALIGNMENT AND PRODUCT MATCHING

(71) Applicant: Laboratory for AI-Powered Financial Tech. Ltd., New Territories (HK)

(72) Inventors: Qingpeng Zhang, New Territories (HK); Houmin Yan, New Territories (HK)

(73) Assignee: Laboratory for AI-Powered Financial Tech. Ltd., New Territories (HK)

(21) Appl. No.: 18/067,774

(22) Filed: Dec. 19, 2022

(30) Foreign Application Priority Data
Nov. 25, 2022 (HK) 32022064763.4

(51) Int. Cl. G06Q 30/0601

(52) U.S. Cl. CPC G06Q 30/0629

(57) ABSTRACT

A data processing module for aligning entities between a first knowledge graph (KG1) and a second knowledge graph (KG2) includes an encoder to embed each entity node of KG1 and KG2 to generate a basic entity representation of each knowledge graph. An aggregator generates a relation representation of each knowledge graph using a first graph attention mechanism; generates an entity embedding including the relation representation using a second graph attention mechanism; concatenates the entity embedding including the relation representation with the basic entity representation to generate a relation-aware entity representation of each knowledge graph; and generates an enhanced entity representation of each knowledge graph comprising a single vector for each embedded entity node using a third graph attention mechanism. A comparator compares each node of the enhanced entity representation of KG1 with each node of the enhanced entity representation of KG2 to generate a similarity matrix between KG1 and KG2.

### FIELD OF THE DISCLOSURE

The present disclosure relates to entity alignment between knowledge graphs and, in particular, the application relates to the problem of cross-platform product matching.

### BACKGROUND OF THE DISCLOSURE

Product matching aims to identify identical or similar products sold on different platforms, which is crucial for retailers to adjust investment strategies and for customers to compare the products. By building knowledge graphs, the product matching problem can be converted to an entity alignment problem, which aims to discover equivalent entities in different knowledge graphs.

E-commerce platforms often build knowledge graphs with their own accumulated data. As each e-commerce platform has different category systems, product description rules and languages etc. the product matching task can be converted to an entity alignment task among cross-language heterogeneous knowledge graphs.

Existing entity alignment methods inadequately utilize both entity attributes and relations between different entities simultaneously, especially the interactions between them. As such, although some knowledge graph based approaches to product matching take the attributes, relations and knowledge graph structure into account, it is difficult to adequately utilize the various pieces of information for product matching.

As well as product matching, entity alignment is useful in combining knowledge graphs used in other contexts e.g. combining question and answer knowledge graphs in different languages. Such tasks are also limited by inadequately utilizing both entity attributes and relations between different entities simultaneously.

It is an object of the present disclosure to address or at least partially ameliorate some of the above problems of the current approaches.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a data processing module for aligning entities between a first knowledge graph (KG1) and a second knowledge graph (KG2), including an encoder configured to embed each entity node of KG1 and KG2 to generate a basic entity representation of each knowledge graph; an aggregator configured to generate a relation representation of each knowledge graph using a first graph attention mechanism, generate an entity embedding including the relation representation using a second graph attention mechanism, concatenate the entity embedding including the relation representation with the basic entity representation to generate a relation-aware entity representation of each knowledge graph, and generate an enhanced entity representation of each knowledge graph comprising a single vector for each embedded entity node using a third graph attention mechanism; and a comparator configured to compare each node of the enhanced entity representation of KG1 with each node of the enhanced entity representation of KG2 to generate a similarity matrix between KG1 and KG2.

The encoder may embed each particular entity node based on the entity name and one or more neighbouring nodes.

The neighbouring nodes may include neighbouring entities, categories, and attributes of the particular node.

The encoder may partition each knowledge graph into a plurality of channels.

The aggregator may generate the basic entity representation for each knowledge graph by generating a basic entity representation in each channel of that knowledge graph.

The comparator may generate the similarity matrix by generating a channel similarity matrix for each channel by comparing the enhanced entity representation in the respective channel of KG1 with the enhanced entity representation in the respective channel of KG2, and combine the plurality of channel similarity matrices to generate the similarity matrix.

Each knowledge graph may be partitioned into a name channel including only the name of each entity node, a structure channel including only neighbouring entity nodes and category nodes of each entity node, a literal channel including only literal attributes of each entity node, wherein literal attributes have an associated text value, and a digital channel including only digital attributes of each entity node, wherein digital attributes have an associated numerical value.

The comparator may combine the channels by average pooling, SVM or a weighted combination.

The data processing module may match products between a first platform and a second platform, wherein products of the first platform are represented by KG1 and products of the second platform are represented by KG2.

The comparator may output, for at least one product of the first platform, a plurality of top-ranked similar products from the second platform based on the similarity matrix.

The data processing module may include a data extractor to build KG1 using structured product data from the first platform and build KG2 using structured product data from the second platform.

The data extractor may build KG1 by parsing unstructured product data from the first platform and build KG2 by parsing unstructured product data from the second platform.

The data processing module may include a rough filter to filter KG1 and KG2 by rules-based matching of product names and categories.

In accordance with a second aspect of the present disclosure, there is provided a computer-implemented method of aligning entities between a first knowledge graph (KG1) and a second knowledge graph (KG2), including embedding each entity node of KG1 and KG2 to generate a basic entity representation of each knowledge graph, using a first graph attention mechanism to generate a relation representation of each knowledge graph, using a second graph attention mechanism to generate an entity embedding including the relation representation, concatenating the entity embedding including the relation representation with the basic entity representation to generate a relation-aware entity representation of each knowledge graph, using a third graph attention mechanism to generate an enhanced entity representation of each knowledge graph comprising a single vector for each embedded entity node, and comparing each node of the enhanced entity representation of KG1 with each node of the enhanced entity representation of KG2 to generate a similarity matrix between KG1 and KG2.

Embedding a particular entity node may be based on the entity name and one or more neighbouring nodes.

The neighbouring nodes may include neighbouring entities, categories, and attributes of the particular node.

The method may include partitioning each knowledge graph into a plurality of channels.

Generating the basic entity representation for each knowledge graph may include generating a basic entity representation in each channel of that knowledge graph; and

Generating the similarity matrix may include generating a channel similarity matrix for each channel by comparing the enhanced entity representation in the respective channel of KG1 with the enhanced entity representation in the respective channel of KG2, and combining the plurality of channel similarity matrices to generate the similarity matrix.

Each knowledge graph may be partitioned into a name channel including only the name of each entity node, a structure channel including only neighbouring entity nodes and category nodes of each entity node, a literal channel including only literal attributes of each entity node, wherein literal attributes have an associated text value, and a digital channel including only digital attributes of each entity node, wherein digital attributes have an associated numerical value.

The channels are combined by average pooling, SVM or a weighted combination.

In accordance with a third aspect of the present disclosure, there is provided a computer-implemented method of matching products between a first platform and a second platform, wherein products of the first platform are represented by a first knowledge graph (KG1) and products of the second platform are represented by a second knowledge graph (KG2), using the entity alignment method of the second aspect;

The method may include, for at least one product of the first platform, outputting a plurality of top-ranked similar products from the second platform based on the similarity matrix.

The method may include building KG1 using structured product data from the first platform and building KG2 using structured product data from the second platform.

The method may include building KG1 by parsing unstructured product data from the first platform and building KG2 by parsing unstructured product data from the second platform.

The method may include a rough filtering stage of filtering KG1 and KG2 by rules-based matching of product names and categories.

In accordance with a fourth aspect of the present disclosure, there is provided a computer-readable medium configured to store instructions which, when executed by a processor, cause the processor to perform the method the second or third aspect.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1 is a schematic diagram showing a data processing module according to an embodiment.

FIG. 2 is a schematic diagram showing a data processing module according to an embodiment.

FIG. 3 is a flowchart showing a method of aligning entities between two knowledge graphs, according to an embodiment.

FIG. 4 is a flowchart showing a method of matching products between a first platform and a second platform, according to an embodiment.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

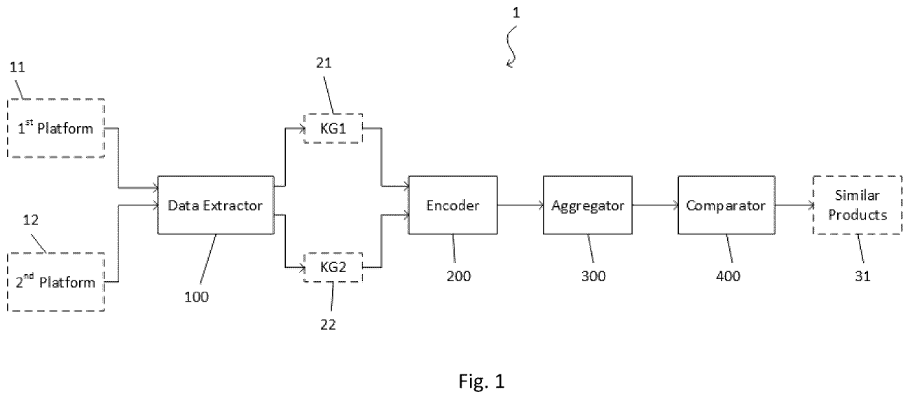

Referring to the drawings, there is shown in FIG. 1 a product matching device 1 configured to match products between a first platform 11 and a second platform 12, for example, between Amazon and eBay. Products of the first platform 11 may be represented by the first knowledge graph 21 (KG1). Products of the second platform 12 may be represented by the second knowledge graph 22 (KG2).

The product matching device 1 comprises a data extractor 100, an encoder 200, an aggregator 300 and a comparator 400.

The data extractor 100 is configured to build KG1 using product data from the first platform 11. The data extractor 100 may build KG1 by parsing unstructured product data from the first platform 11 and/or by using structured product data from the first platform 11.

The data extractor 100 is further configured to build KG2 using product data from the second platform 12. The data extractor 100 may build KG2 by parsing unstructured product data from the second platform 12 and/or by using structured product data from the second platform 12.

In some examples, the data extractor 100 may be configured to use a natural language processing model e.g. for universal information extraction (UIE) such as Paddle UIE.

Each knowledge graph may up of entity nodes. For example, some entity nodes may represent products, and others may represent categories, stores or brands. The relations between entity nodes may indicate products belonging to categories, stores or brands. In some examples, multiple relations may connect products with different categories, stores or brands. In some examples, relations may link different layers of categories.

In some examples, other nodes of the knowledge graphs may be attributes. Attributes may be linked to entity nodes e.g. representing products having those attributes. In some examples, some attributes may include product colours, size, target customers etc. In some examples, attributes may be separated into “literal” attributes, i.e. the value of the attribute is a word, and “digital” attributes, i.e. the value is a number. In some examples, the attributes may be extracted using one or more regular expression rules. Alternatively, the attributes may be extracted using a natural language processing model e.g. for universal information extraction (UIE) such as Paddle UIE.

In this way, each knowledge graph may be configured as a set of triples. For example, each knowledge graph may be divided into attribute triples (between an entity, e.g. a product, and an attribute) and relation triples (between entities, e.g. between a product and a category).

In some examples, the data extractor 100 may be omitted and suitable knowledge graphs can be obtained by other means e.g. received from another source.

The encoder 200 is configured to embed each entity node of KG1 and KG2 to generate a basic entity representation of each knowledge graph. That is, the encoder 200 may be configured to generate a vector representation for each entity, representing a product, in the knowledge graph. In this way, a basic embedding is generated including information of each entity, influenced by neighbours but with no information on the relations.

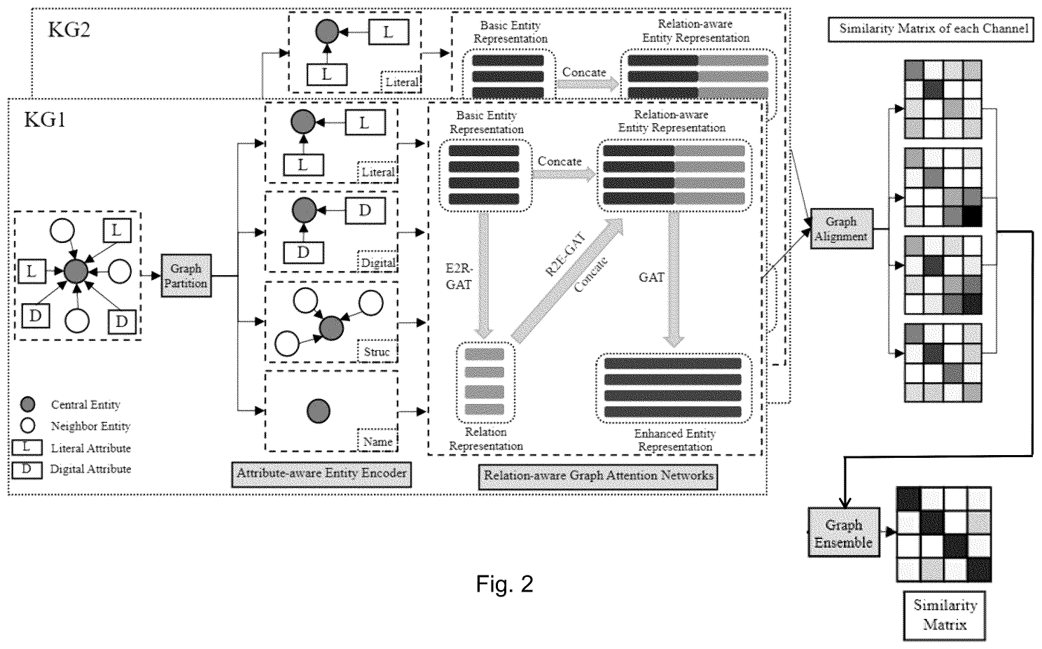

The aggregator 300 is configured to generate an enhanced entity representation including a relation representation, as described with respect to FIG. 2 below. That is, a product embedding is generated with more information of neighbour entities included into embedding of central entity, e.g. information on the relations, attributes and graph structure.

The comparator 400 is configured to compare each node of the enhanced entity representation of KG1 with each node of the enhanced entity representation of KG2 to generate a similarity matrix between KG1 and KG2.

In some examples, the similarity matrix may include as eigenvalues a similarity between each entity of KG1 and each entity of KG2. For example, the similarity matrix may include a similarity between each product entity of KG1 and each product entity of KG2. As such, the dimensions of the similarity matrix may be the number of product entities in KG1×the number of product entities in KG2. For example, the number of products on the first platform 11×the number of products on the second platform 12. In some examples, the similarity may be measured with the cosine distance of their vector representations.

The comparator 400 is further configured to output, for at least one product of the first platform 11, a plurality of top-ranked similar products 31 from the second platform 12 based on the similarity matrix. For example, the comparator 400 may be configured to provide the top-K similar Amazon products for a certain eBay product or vice versa.

In this way, the product matching device 1 provides an effective and efficient method for product matching. This can be beneficial in e-commerce for a variety of users. For consumers, purchasing a product from a certain platform is usually based on the comparison across different platforms. Meanwhile, for both retailers and platform managers, comparing their products with competitors can help them to grasp market information. Thus, product matching is a common task essential for many users. By improving the effectiveness of a product matching process, this task can be carried out more efficiently. More generally, such cross-platform behaviour and similar knowledge graph alignment tasks are important yet under-researched and so the solution of the product matching device 1 can improve the efficiency and effectiveness of many such tasks.

FIG. 2 shows a data processing module for aligning entities between a first knowledge graph (KG1) and a second knowledge graph (KG2). The data processing module comprises an encoder 200, an aggregator 300 and a comparator 400. The data processing module may be referred to as a relation-aware, and attribute-aware graph attention networks for entity alignment (RAEA) model.

The encoder 200 is configured to embed each entity node of KG1 and KG2 to generate a basic entity representation of each knowledge graph. In some examples, the encoder 200 may perform the embedding using a natural language processing model. In some examples, a transformer-based machine learning technique may be used e.g. Bidirectional Encoder Representations from Transformers (BERT), XL-net, MP-net or similar.

In some examples, the encoder 200 may be trained using contrast learning. For example, the encoder 200 may be trained using an unsupervised SimCSE process. That is, the encoder 200 may be configured to generate two similar but different embeddings as a positive pair and the rest as negative pairs for each text entered. In this way, the trained encoder 200 can provide improved semantic similarity performance.

In some examples, the encoder 200 may be configured to embed each particular entity node based on the entity name and one or more neighbouring nodes. In some examples, the neighbouring nodes may include neighbouring entities, categories, and attributes of the particular node.

As described above, some entity nodes may represent products, and others may represent categories, stores or brands. In some examples, neighbours may be defined based on the target node for each embedding i.e. the central node. The neighbour entities may be any linked nodes accessed through one link, described as a 1-hop neighbour. In some examples, 2-hop and 3-hop neighbours may also influence the embedding of the central entity.

In some examples, the encoder 200 may be configured the embed product nodes only, such that the central entity is always a product. Where the central entity is a product, a neighbour entity can be a node representing a category/brand/store, or may be an attribute node. In some examples, attributes may be separated into “literal” attributes, i.e. the value of the attribute is a word, and “digital” attributes, i.e. the value is a number.

In some examples, the encoder 200 may be configured to partition each knowledge graph into a plurality of channels, prior to encoding.

In some examples, the plurality of channels may include a name channel including only the name of each entity node. That is, the name channel may include attribute triples of the name only.

In some examples, the plurality of channels may include a structure channel including only neighbouring entity nodes and category nodes of each entity node. That is, the structure channel may include no attribute triples.

In some examples, the plurality of channels may include a literal channel including only literal attributes of each entity node, wherein literal attributes have an associated text value. That is, the literal channel may include only attribute triples of literal values.

In some examples, the plurality of channels may include a digital channel including only digital attributes of each entity node, wherein digital attributes have an associated numerical value. That is, the digital channel may include only attribute triples of digital values.

In some examples, the aggregator 300 is configured to generate the basic entity representation for each knowledge graph by generating a basic entity representation in each channel of that knowledge graph. The subsequent processing of the aggregator 300 may be performed on each channel separately.

The aggregator 300 is configured to generate a relation representation of each knowledge graph using a first graph attention mechanism. The first graph attention mechanism may be referred to as an entity-to-relation graph attention mechanism (E2R GAT). In some examples, the relation representation may be configured to distinguish the embedding of two different relations between same two nodes, which may not be present in certain knowledge graphs.

The aggregator 300 is further configured to generate an entity embedding including the relation representation using a second graph attention mechanism. In this way, the second graph attention mechanism may be configured to generate an embedding of the relations. The second graph attention mechanism may be referred to as a relation-to-entity graph attention mechanism (R2E GAT).

The aggregator 300 is further configured to concatenate the entity embedding including the relation representation with the basic entity representation to generate a relation-aware entity representation of each knowledge graph. In this way, the aggregator 300 may be configured to combine the entity embedding with the relation embedding.

The aggregator 300 is further configured to generate an enhanced entity representation of each knowledge graph comprising a single vector for each embedded entity node using a third graph attention mechanism. In this way, the aggregator 300 can provide an entity representation with more information about the relations.

The comparator 400 is configured to compare each node of the enhanced entity representation of KG1 with each node of the enhanced entity representation of KG2 to generate a similarity matrix between KG1 and KG2.

In some examples, the similarity matrix may include as eigenvalues a similarity between each entity of KG1 and each entity of KG2. For example, the similarity matrix may include a similarity between each product entity of KG1 and each product entity of KG2. As such, the dimensions of the similarity matrix may be the number of product entities in KG1×the number of product entities in KG2. Similarity may be measured with the cosine distance of their vector representations.

In some examples, the comparator 400 may be configured to generate the similarity matrix by generating a channel similarity matrix for each channel by comparing the enhanced entity representation in the respective channel of KG1 with the enhanced entity representation in the respective channel of KG2.

The comparator 400 may be configured to combine the plurality of channel similarity matrices to generate the similarity matrix. In some examples, the comparator 400 may be configured to combine the channels by average pooling, SVM or a weighted combination. In some examples, the weights for each combination may be based on test results from a test set, e.g. known equivalent product entities on two platforms.

In some examples, the data processing module may include a rough filter. The rough filter may be configured to filter KG1 and KG2 by rules-based matching of entities. For example, the rough filter may match product names (or any entity titles in an equivalent task) and categories based on rules e.g. to provide a candidate set of products from the second platform 12 for each product of the first platform 11 (or vice versa). In some examples, the rough filter may be configured to use regular expressions. For example, the regular expressions may simulate the process of a user searching for a specific product of the first platform 11 in the database of the second platform 12, wherein the keywords of the matching criteria must identify the subject of the product. In some examples, a plurality of hierarchical categories and, optionally, one or more products of the second platform 12 may be concatenated. The rough filter may be arranged prior to the encoder 200.

In this way, the accuracy of an entity alignment task such as product matching may be improved, using a two-stage pipeline. That is, the number of candidate products may be greatly reduced by the rough filter and more reliable matching results may be output by the RAEA model.

As described above, the RAEA data processing module can leverages attributes and relations simultaneously and explore the interaction between them for better entity embeddings. By accounting for the diversity of relations between two entities, the data processing module can distinguish the importance of different relation types between two entities. By using the embedding of an entity to generate the embedding of a relation, and updating the embedding of entity with the relation embedding, the resulting enhanced entity embedding can be used to distinguish different importance of relation types.

In some examples, the data processing module may be configured for product matching. For example, the data processing module may be provided as part of the product matching device 1 of FIG. 1. Alternatively, the data processing module may include one or more additional functional units, e.g. a data extractor 100, to perform product matching. Alternatively, the data processing module may be provided in isolation as described with respect to FIG. 2 and configured to perform any entity alignment task between two knowledge graphs e.g. to fuse complementary question and answer knowledge graphs in different languages.

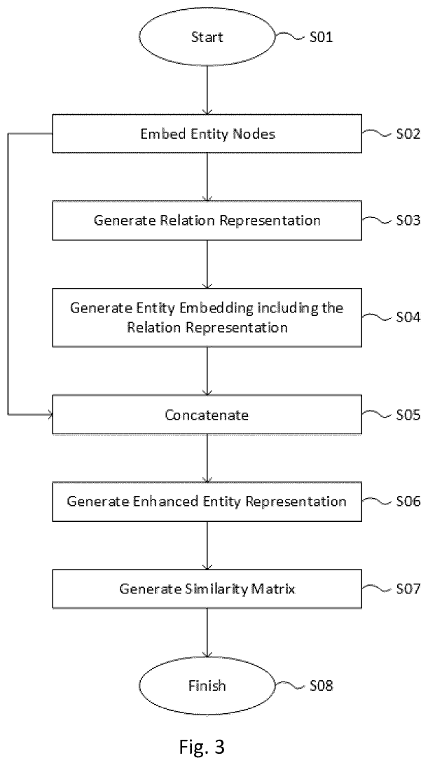

FIG. 3 is a flowchart showing a method of aligning entities between two knowledge graphs (KG1, KG2), according to an embodiment. The method starts at step S01.

At step S02, each entity node of KG1 and KG2 is embedded to generate a basic entity representation of each knowledge graph.

At step S03, a relation representation of each knowledge graph is generated using a first graph attention mechanism.

At step S04, an entity embedding including the relation representation is generated using a second graph attention mechanism.

At step S05, the entity embedding including the relation representation is concatenated with the basic entity representation to generate a relation-aware entity representation of each knowledge graph.

At step S06, an enhanced entity representation of each knowledge graph comprising a single vector for each embedded entity node is generated using a third graph attention mechanism.

At step S07, each node of the enhanced entity representation KG1 is compared with each node of the enhanced entity representation of KG2 to generate a similarity matrix between KG1 and KG2.

The method finishes at step S08.

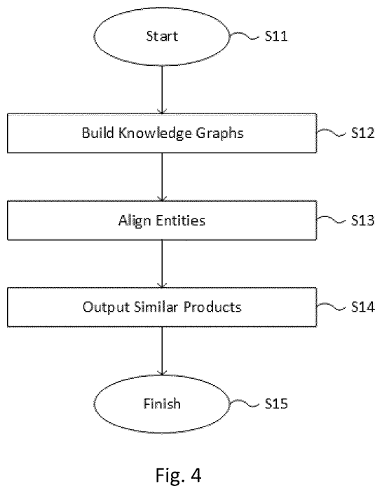

FIG. 4 is a flowchart showing a method of matching products between a first platform and a second platform, according to an embodiment. The method starts at step S11.

At step S12, the first and second knowledge graphs (KG1, KG2) are built using structured and/or unstructured product data from a first platform and a second platform respectively.

At step S13, the entities of KG1 and KG2 are aligned using the method described with respect to FIG. 3, generating a similarity matrix between KG1 and KG2.

At step S14, a plurality of top-ranked similar products from the second platform are output for at least one product of the first platform based on the similarity matrix.

The method finishes at step S15.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A data processing module for aligning entities between a first knowledge graph, KG1, and a second knowledge graph, KG2, the data processing module comprising:
an encoder configured to embed each entity node of KG1 and KG2 to generate a basic entity representation of each knowledge graph;
an aggregator configured to:
generate a relation representation of each knowledge graph using a first graph attention mechanism;
generate an entity embedding including the relation representation using a second graph attention mechanism;
concatenate the entity embedding including the relation representation with the basic entity representation to generate a relation-aware entity representation of each knowledge graph; and
generate an enhanced entity representation of each knowledge graph comprising a single vector for each embedded entity node using a third graph attention mechanism; and
a comparator configured to compare each node of the enhanced entity representation of KG1 with each node of the enhanced entity representation of KG2 to generate a similarity matrix between KG1 and KG2.

2. The data processing module of claim 1, wherein the encoder is configured to embed each particular entity node based on the entity name and one or more neighbouring nodes.

3. The data processing module of claim 2, wherein the neighbouring nodes include neighbouring entities, categories, and attributes of the particular node.

4. The data processing module of claim 1,
wherein the encoder is further configured to partition each knowledge graph into a plurality of channels,
wherein the aggregator is configured to generate the basic entity representation for each knowledge graph by generating a basic entity representation in each channel of that knowledge graph; and
wherein the comparator is configured to generate the similarity matrix by generating a channel similarity matrix for each channel by comparing the enhanced entity representation in the respective channel of KG1 with the enhanced entity representation in the respective channel of KG2, and combine the plurality of channel similarity matrices to generate the similarity matrix.

5. The data processing module of claim 4, wherein each knowledge graph is partitioned into:
a name channel including only the name of each entity node,
a structure channel including only neighbouring entity nodes and category nodes of each entity node;
a literal channel including only literal attributes of each entity node, wherein literal attributes have an associated text value; and
a digital channel including only digital attributes of each entity node, wherein digital attributes have an associated numerical value.

6. The data processing module of claim 4, wherein the comparator is configured to combine the channels by average pooling, SVM or a weighted combination.

7. The data processing module of claim 1, configured to match products between a first platform and a second platform, wherein products of the first platform are represented by the first knowledge graph, KG1, and products of the second platform are represented by the second knowledge graph, KG2;
wherein the comparator is further configured to output, for at least one product of the first platform, a plurality of top-ranked similar products from the second platform based on the similarity matrix.

8. The data processing module of claim 7, further comprising a data extractor configured to build KG1 using structured product data from the first platform and build KG2 using structured product data from the second platform.

9. The data processing module of claim 7, further comprising a data extractor configured to build KG1 by parsing unstructured product data from the first platform and build KG2 by parsing unstructured product data from the second platform.

10. The data processing module of any one of claim 7, further comprising a rough filter configured to filter KG1 and KG2 by rules-based matching of product names and categories.

11. A computer-implemented method of aligning entities between a first knowledge graph, KG1, and a second knowledge graph, KG2, the method comprising:
embedding each entity node of KG1 and KG2 to generate a basic entity representation of each knowledge graph;
using a first graph attention mechanism to generate a relation representation of each knowledge graph;
using a second graph attention mechanism to generate an entity embedding including the relation representation;
concatenating the entity embedding including the relation representation with the basic entity representation to generate a relation-aware entity representation of each knowledge graph;
using a third graph attention mechanism to generate an enhanced entity representation of each knowledge graph comprising a single vector for each embedded entity node; and
comparing each node of the enhanced entity representation of KG1 with each node of the enhanced entity representation of KG2 to generate a similarity matrix between KG1 and KG2.

12. The computer-implemented method of claim 11, wherein the embedding of a particular entity node based on the entity name and one or more neighbouring nodes.

13. The computer-implemented method of claim 12, wherein the neighbouring nodes include neighbouring entities, categories, and attributes of the particular node.

14. The computer-implemented method of claim 11, further comprising partitioning each knowledge graph into a plurality of channels,
wherein generating the basic entity representation for each knowledge graph includes generating a basic entity representation in each channel of that knowledge graph; and
wherein generating the similarity matrix comprises generating a channel similarity matrix for each channel by comparing the enhanced entity representation in the respective channel of KG1 with the enhanced entity representation in the respective channel of KG2, and combining the plurality of channel similarity matrices to generate the similarity matrix.

15. The computer-implemented method of claim 14, wherein each knowledge graph is partitioned into:
a name channel including only the name of each entity node,
a structure channel including only neighbouring entity nodes and category nodes of each entity node;
a literal channel including only literal attributes of each entity node, wherein literal attributes have an associated text value; and
a digital channel including only digital attributes of each entity node, wherein digital attributes have an associated numerical value.

16. The computer-implemented method of claim 14, wherein the channels are combined by average pooling, SVM or a weighted combination.

17. A computer-implemented method of matching products between a first platform and a second platform, wherein products of the first platform are represented by a first knowledge graph, KG1, and products of the second platform are represented by a second knowledge graph, KG2, using the entity alignment method of claim 11;
wherein the method further comprises, for at least one product of the first platform, outputting a plurality of top-ranked similar products from the second platform based on the similarity matrix.

18. The computer-implemented method of claim 17, further comprising building KG1 using structured product data from the first platform and building KG2 using structured product data from the second platform.

19. The computer-implemented method of claim 17, further comprising building KG1 by parsing unstructured product data from the first platform and building KG2 by parsing unstructured product data from the second platform.

20. The computer-implemented method of claim 17, further comprising a rough filtering stage of filtering KG1 and KG2 by rules-based matching of product names and categories.

21. A computer-readable medium configured to store instructions which, when executed by a processor, cause the processor to perform the method of claim 11.
